(19) United States
(12) Patent Application Publication
(10) Pub. No.: US 2003/0179727 A1
(43) Pub. Date: Sep. 25, 2003

(54) Forward link supervision for packet data users in a wireless communication network

(76) Inventors: Anthony C.K. Soong, Superior, CO (US); Seong-Jun Oh, San Diego, CA (US); Sanjeev Arvind Athalye, San Diego, CA (US); David Reeves Comstock, San Diego, CA (US)

Correspondence Address: COATS & BENNETT, PLLC, P O BOX 5, RALEIGH, NC, 27602, US

(21) Appl. No.: 10/223,838

(22) Filed: Aug. 20, 2002

Related U.S. Application Data
(60) Provisional application No. 60/366,431, filed on Mar. 21, 2002.
(60) Provisional application No. 60/373,082, filed on Apr. 16, 2002.

(51) Int. Cl. H04Q 7/00

(52) U.S. Cl. 370/328; 370/458

(57) ABSTRACT

A method and apparatus for link supervision determines whether a link signal is present or absent by measuring received energy for that signal. If the measured energy for the signal does not meet a defined energy threshold according to defined evaluation criteria, such as a sufficiency metric, the signal is deemed absent. Applied to wireless communication networks, such supervision may be used to suspend or terminate transmission responsive to detecting the link signal's absence. In an exemplary embodiment for 1×EV-DV (cdma2000 Revision C) wireless networks, a mobile station selectively performs forward link supervision based on measuring the bit energy of power control bits received by the mobile on a dedicated power control sub-channel. If a fundicated channel is assigned to the mobile station, it may perform forward link supervision based on Frame Error Rate (FER) estimations for data received on the fundicated channel rather than the energy-based approach.

### RELATED APPLICATIONS

This application claims priority under 35 U.S.C. § 119(e) from the following U.S. provisional applications: application Ser. No. 60/366,431 filed on Mar. 21, 2002, and application Ser. No. 60/373,082 filed on Apr. 16, 2002. These applications are expressly incorporated in their entireties by reference herein.

### BACKGROUND OF THE INVENTION

The present invention generally relates to wireless communication networks management, and particularly relates to forward link supervision for packet data users without benefit of a dedicated forward link channel.

Wireless communication networks generally use link supervision as an integral part of their overall control schemes. For example, in many types of cellular communication networks, mobile stations perform forward link supervision to determine whether a supporting base station has ungracefully “dropped” a call, i.e., dropped without successfully negotiating the drop with the mobile station, and whether forward link channel conditions have deteriorated below acceptable quality or data integrity thresholds. Normally, such forward link supervision involves monitoring of either a dedicated traffic channel or a dedicated control channel by the mobile station.

A dedicated channel generally is one that is exclusively associated with a given mobile station. For example, in communication networks based on the Telecommunication Industry Association's (TIA) Interim Standard (IS) 2000, Revision B or earlier, each mobile station is usually supported by one or more dedicated forward link channels. In IS-2000 networks, each active mobile station usually has at least one dedicated forward link channel, such as a Forward-Fundamental Channel (F-FCH) or Forward-Dedicated Control Channel (F-DCCH). The term “fundicated” channel is a term of art describing either a dedicated fundamental channel or a dedicated control channel.

The availability of a fundicated channel greatly simplifies forward link supervision. Generally, the traffic or control data signal transmitted by the network to a mobile station on a fundicated channel includes error detection coding thus enabling the mobile station to verify error-free receipt of the data. Commonly, such error detection coding uses Cyclic Redundancy Codes (CRCs). CRC usage is a well-known form of block-coding that permits the mobile station to verify the integrity of a given block of data by validating the CRC value received in association with that data block.

Thus, with the availability of CRCs on its fundicated channel, the mobile station performs forward link supervision by evaluating the receipt of “good” (valid CRC) and “bad” (invalid CRC) data. If the mobile station observes an unacceptably high incidence of bad data blocks, normally assessed on a per frame basis, the mobile station increases the desired signal-to-noise ratio (SNR) in its outer power control loop. The mobile station's inner power control loop compares the received SNR with the desired SNR, and directs the network, using power control commands sent from the mobile station to the network on the mobile station's reverse link, to increase transmit power if the received SNR is less than the desired SNR. Requesting such increases results in the network increasing the transmit power of the forward link fundicated channel.

If requests for increased transmit power do not alleviate the unacceptably high incidence of bad data received on the fundicated channel, this indicates that the supporting base station has dropped the channel or that channel conditions have deteriorated because of interference, fading, etc. In any case, upon recognizing the effective loss of the forward link channel, the mobile station might take several actions.

Cessation of reverse link transmissions by the mobile station is a common response to the recognized loss of the forward link fundicated channel. Termination of reverse link transmission rests on the twofold reasoning that reverse link power control commands received by the mobile station on the forward link are no longer reliable and, hence, reverse link transmit power is no longer well controlled, and because the loss of the forward link channel may result from the base station's actual termination of the call.

Error detection coding of fundicated channel data and the mobile's ability to power control the channel represent the enabling elements in the above approach to forward link supervision. That is, the availability of CRCs on a periodic basis and the ability to request increased channel power responsive to observing received data errors form the basis for a given mobile station to perform ongoing forward link supervision. As an example, the mobile station might use CRCs to assess received frames of data as either good or bad, and use some defined threshold of repeated bad frames as the trigger for determination of channel loss or degradation.

Thus, the above approach becomes problematic in networks where mobile stations do not necessarily have a fundicated channel on which forward link supervision can be based. The developing 1×EV-Data and Voice (1×EV-DV) standard (IS2000 Revision C) represents a network architecture in which mobile stations may not have a forward link fundicated channel on which forward link supervision might be based. A looming challenge in such systems is to make forward link supervision reliable without benefit of CRC-based supervision available with fundicated channel supervision.

### BRIEF SUMMARY OF THE INVENTION

The present invention provides a method and apparatus for link supervision based on detecting the received energy of a relatively continuous or sufficiently high duty cycle signal received on a communication channel associated with the link to be supervised. In an exemplary embodiment, channel supervision is based on detecting bit energies of the received signal and determining whether the channel is active and whether the channel quality is acceptable (sufficient or insufficient). Such determination may be made by comparing received bit energies to one or more defined thresholds according to some evaluation criteria, such as a defined “sufficiency metric” specifying, for example, how long or how many times received energy may fall below the defined threshold. Such an approach enables, for example, reliable forward link supervision in 1×EV-DV wireless communication networks based on a mobile station monitoring the received bit energies on its assigned power control sub-channel in the Forward-Common Power Control Channel (F-CPCCH) signal. Thus, the present invention enables reliable forward link channel supervision where the mobile station does not have an assigned fundicated channel.

In an exemplary embodiment, the mobile station performs forward link supervision using a data-error based approach if a fundicated channel signal is available, and performs forward link supervision using the energy-based approach on an alternate channel signal, such as the F-CPCCH sub-channel signal, if the fundicated channel is not available. In using the alternate channel, the mobile station might adopt any one of a variety of approaches as regards bit energy evaluation for channel supervision. In an exemplary 1×EV-DV embodiment, the mobile station treats the F-CPCCH as a framed channel consistent with the framing structure used on, for example, fundicated channels in cdma2000 1× systems. In this embodiment, the 800 Hz Power Control Bits (PCBs) received on the mobile's assigned F-CPCCH sub-channel are “framed” and evaluated using defined frame rate timing, such as twenty-millisecond timing.

Indeed, this framing approach may be structured to mimic the CRC-based fundicated channel supervision used in cdma2000 1× forward link supervision, which bases channel supervision on receiving defined numbers of “bad” or “good” frames as a function of detected data errors. In the energy-based approach, the bad and good frame determinations are based on measured bit energy rather than detected data errors.

In another exemplary embodiment, the mobile station foregoes the frame-based approach to PCB energy evaluation. As such, the mobile station instead uses various other exemplary non-frame based processing, such as sliding-window coherent or non-coherent combining of received PCBs that allows the mobile station to make “soft” decisions about whether the supervised channel is active or inactive (present or absent), or whether it has degraded below the point of usefulness or reliability.

Regardless of the particular technique used for the bit energy evaluation, the defined energy thresholds used for evaluating received bit energy may be set in consideration of desired detection reliabilities. The network may adjust the channel detection reliability by setting the threshold of detected bit energy to power spectral noise density (Eb/Nt) to a given threshold. With these approaches, increasing the acceptable threshold of Eb/Nt increases the reliability of detection. Of course, the level at which energy detection threshold(s) is established is selected based on balancing detection reliability against the false alarm probability. Here, a false alarm represents a falsely reported absence (loss or degradation) of the supervised channel.

### BRIEF DESCRIPTION OF THE DRAWINGS

FIG. 1 is a diagram of an exemplary wireless communication network for practicing the present invention.

FIG. 2 is a diagram illustrating exemplary reverse and forward link channels.

FIG. 3A is a diagram of exemplary flow logic for FER-Based Link Supervision versus Energy-Based Link Supervision based on whether a fundicated channel is assigned.

FIG. 3B is a diagram illustrating exemplary flow logic for energy-based link supervision.

FIG. 4A is a diagram illustrating exemplary framing logic for the measurement of received bit energy.

FIG. 4B is a diagram of an exemplary sliding-window based approach to measuring received bit energy.

FIG. 5 is an exemplary diagram of a defined energy threshold for bit energy evaluation in relation to signal and noise energy.

FIG. 6 is a diagram of an exemplary diagram of average bit area probability of declaring a frame as bad.

FIG. 7 is a diagram illustrating an exemplary diagram of the probability of not observing a given number of consecutive bad frames.

FIG. 8 is a diagram of the probability of not observing twelve consecutive bad frames for various Eb/No.

FIG. 9 is a diagram of the probability of not observing 24 consecutive bad frames for various received Eb/No.

FIG. 10 is a diagram of the probability of not observing 12 consecutive bad frames for various channel models based on an average received Eb/No.

FIG. 11 is a diagram of the probability of not observing 12 consecutive bad frames for various channel models with an average received Eb/No=0 dB.

FIG. 12 is a diagram of the probability that six consecutive good frames are not detected for various received Eb/No's in the AWGN case.

FIG. 13 is a diagram of the probability that six consecutive good frames are not observed for various channel models with an average received Eb/No=0 dB.

FIG. 14 is a diagram of the probability that six consecutive good frames are not observed for various channel models with an average received Eb/No=4 dB.

FIG. 15 is a diagram of the probability that four consecutive good frames are not observed for several channel models at various Eb/No's.

### DETAILED DESCRIPTION OF THE INVENTION

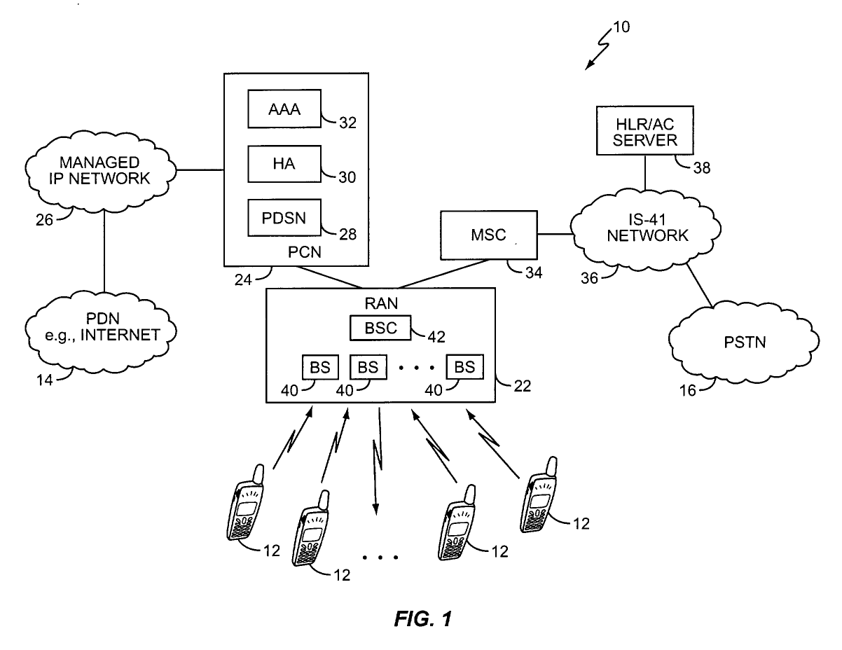

FIG. 1 illustrates an exemplary wireless communication network generally referred to by the numeral 10. Here, network 10 communicatively couples one or more mobile stations 12 to a Packet Data Network (PDN) 14 such as the Internet, and to the Public Switch Telephone Network (PSTN) 16. Thus, network 10 provides users of mobile stations 12 with various voice and data services. For packet data services, a Radio Access Network (RAN) 22 is coupled to a Packet Core Network (PCN) 24, which is in turn coupled to the PDN 14 through a managed IP network 26. For voice and other circuit-switched services, such as fax-based data services, the RAN 22 is coupled to a Mobile Switching Center (MSC) 34, which is in turn coupled to the PSTN 16 through an IS-41 network 36. The IS-41 network 36 generally provides access to various other network entities, such as an HLR/AC server 38, which provides Home Location Register and Access Control Services.

RAN 22 generally comprises a plurality of Base Stations (BSs) 40, which provide radio communication between the various mobile stations 12 and the RAN 22. In an exemplary embodiment, groups of one or more BSs 40 are associated with a Base Station Controller (BSC) 42. In an actual implementation, RAN 22 may comprise multiple BSCs 42, each of which supports a plurality of BSs 40.

The above network description is generally consistent with 1×EV-DV network standards, in which mobile stations 12 are provided a variety of packet data invoice services. While the present invention is in no way limited to use in such networks, 1×EV-DV systems provide an exemplary framework for discussing various exemplary embodiments of the inventive channel supervision of the present invention.

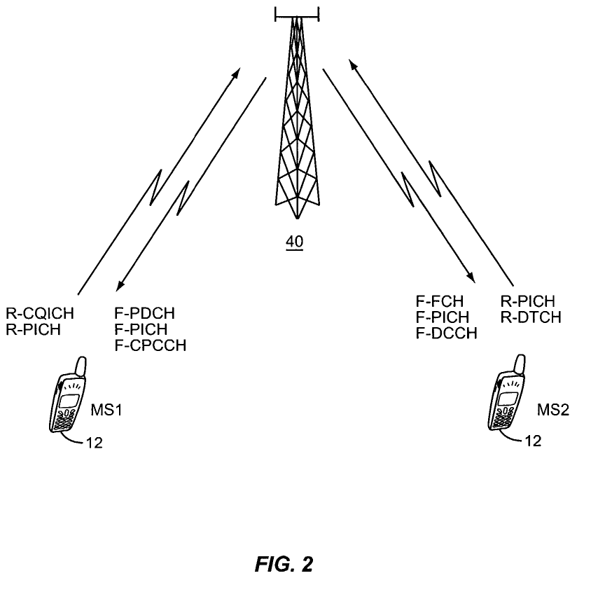

Communication channel assignments as regards communications between a given mobile station 12 in the network 10 depend upon the nature of the communication involved. For example, FIG. 2 illustrates two different mobile stations 12, denoted as MS1 and MS2, each engaged in a different type of call or data session with the network 10. Here, MS1 is engaged in a high-speed packet data call and as such receives scheduled service on the Forward-Packet Data Channel (F-PDCH) but is not assigned with a dedicated control or traffic channel. MS1 might further receive a Forward-Pilot Channel (F-PICH) signal and a sub-channel power control signal on the Forward-Common Power Control Channel (F-CPCCH). On the reverse link, MS1 transmits a channel quality indicator signal on the Reverse-Channel Quality Indicator Channel (R-CQICH), which is used by the serving BS 40 to control the data rate at which MS1 is served on the F-PDCH. The R-CQICH signal transmitted by MS1 may also be used by the serving BS 40 to control the power of the power control sub-channel signal transmitted to MS1 on the F-CPCCH.

MS2 may be involved in lower speed packet data communications and/or may be involved in one or more voice services. As such, MS2 is assigned at least one dedicated forward link traffic channel, such as a forward link Fundamental Channel (F-FCH), or a Dedicated Forward Link Control Channel, F-DCCH). Dedicated forward link data and control channels are generically referred to as fundicated channels. Thus, in this general allocation scenario, MS2 has at least one forward link fundicated channel assigned to it.

With the assignment of at least one fundicated channel, MS2 may supervise the forward communication link from BS 40 based on the conventional Frame Error Rate (FER) approach. With FER-based supervision, MS2 detects the incidence of error in data frames received on the fundicated channel, and if the estimated frame error rate exceeds the defined error rate threshold, MS2 may assume that the forward link has been lost. One benefit to such supervision, particularly in an interference-limited environment, is that MS2 may suspend or otherwise shut down its reverse link transmissions responsive to determining that the forward link has been lost. Such operation provides something of a “safety net” that provides for relatively orderly shut down of transmissions, even where formal indication of call termination is not received from BS 40.

In contrast, MS1 is not assigned a fundicated channel, and has only dynamically scheduled service times on the F-PDCH. In terms of a persistent channel, MS1 has only the power control sub-channel assigned to it on the F-CPCCH. The power control sub-channel assigned to MS1 represents a time multiplexed slice of the F-CPCCH on which BS 40 transmits power control signal in the form of 800 Hz power control bits, which are used by MS1 to control its reverse link transmit power.

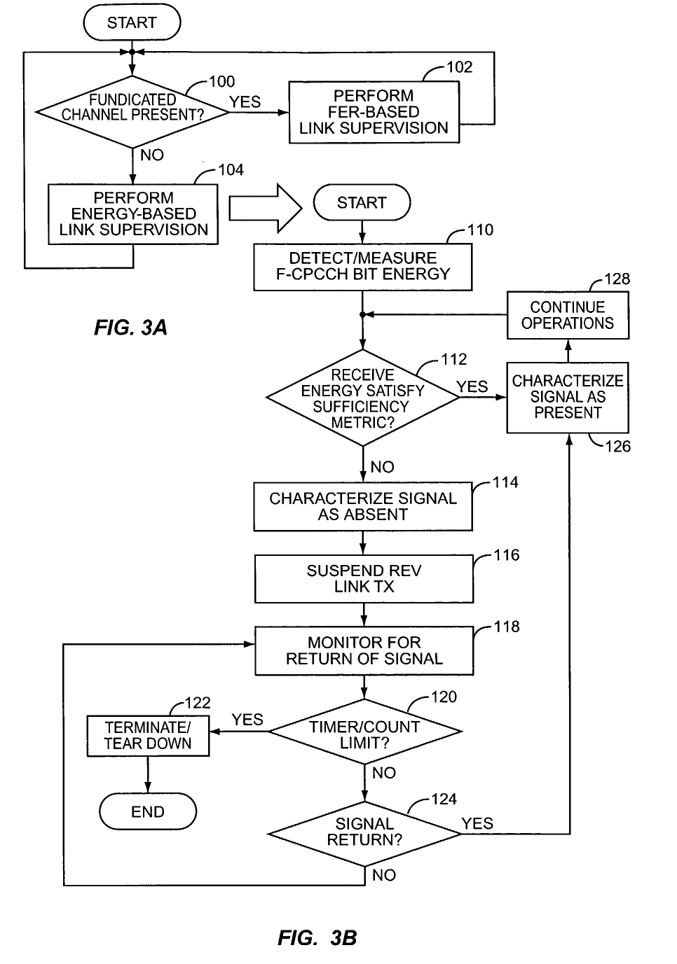

FIG. 3a illustrates en exemplary embodiment of link supervision according to the present invention. It should be understood that the processing illustrated in FIGS. 3a and 3b are generally not implemented as stand alone operations and simply represent one aspect of mobile station operations necessary to support the overall communication function. Assuming a given mobile station 12 has a connection to the network 10, processing begins with a mobile station determining whether it has a fundicated channel assigned to it (Step 100). If so, the mobile station 12 performs forward link supervision based on evaluating the frame error rate for data received in the fundicated channel signal (Step 102). If no fundicated channel is assigned to the mobile station 12, it performs forward link supervision using an exemplary energy-based approach (Step 104).

FIG. 3b illustrates exemplary details for energy-based link supervision. Processing begins with the mobile station 12 detecting/measuring bit energies of the Power Control Bits (PCBs) received on the sub-channel signal of the F-CPCCH (Step 110). Mobile station 12 determines whether the received energy of the PCBs satisfies a defined sufficiency metric, which may involve comparing received energy to an energy threshold over a qualifying time period (Step 112). If the received bit energy does not satisfy the sufficiency metric, mobile station 12 characterizes the power control signal as absent (Step 114), and, in response, it suspends its reverse link transmissions to the network 10 (Step 116).

In an exemplary embodiment, mobile station 12 monitors for the return of the power control signal once it has suspended its reverse link transmissions (Step 118). Such monitoring allows the mobile station 12 to detect whether the loss of the forward link signal represents the temporary loss, or whether continued monitoring of the channel indicates that the network 10 has dropped its connection with the mobile station 12. Thus, as part of its monitoring, the mobile station 12 runs a timer/counter limit during its return monitoring loop (Step 120). If the signal absence timer or counter has reached its limit, mobile station 12 terminates its reverse link transmissions and may perform various call tear-down procedures (Step 122).

If the timer/counter has not expired, mobile station continues its evaluation of received signal energy to determine whether the forward link signal has returned (Step 124). If not, mobile station 12 continues its monitoring subject to the limitations to the timer/counter. If mobile station 12 detects a return of the forward link signal, mobile station 12 characterizes the signal as present and continues or resumes operations in association with supporting its communication connection to the network 10 (Steps 126 and 128). If mobile station 12 resumes operations, it continues forward link supervision based on received energy evaluation as described above.

Thus, as a generalization of the above approach, the mobile station 12 performs energy-based forward link supervision based on determining whether the monitored signal, e.g., the power control subchannel signal, is received and has sufficient (is above the energy threshold) or insufficient (is below the energy threshold) signal quality. With this basis, if the signal quality remains insufficient for a defined period, the mobile station 12 may suspend reverse link transmission. While such transmission is suspended, the mobile station 12 may continue with time-qualified evaluation of the received signal to detect the signal's time-qualified return to sufficient signal quality within the suspension time-out period. If such return is detected, the mobile station 12 may re-enable reverse link transmission, and if not, it may terminate such transmission.

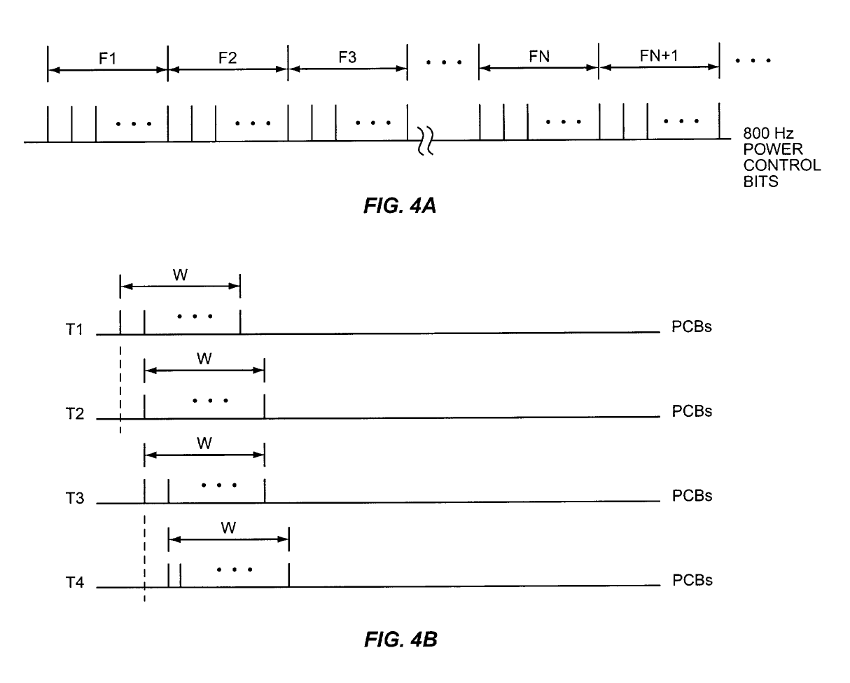

FIG. 4a illustrates an exemplary approach to energy-based forward link supervision in which the 800 Hz PCB's received on the F-CPCCH sub-channel are “framed” by the mobile station 12. That is, mobile station 12 treats the 800 Hz continuous stream of PCB's as a framed channel comprising successive frames of PCB's. In an exemplary embodiment, mobile station 12 frames power control sub-channel using frame timing characteristics consistent with fundicated channel framing used in cdma2000 1× systems. As such, mobile station 12 groups received PCB's into 20 millisecond frames, with each frame comprising one Power Control Group (PCG) of 16 PCB's. With this approach, mobile station 12 may mimic the FER-Based Channel Supervision used when a fundicated channel is available. In other words, mobile station 12 may use the same bad frame/good frame criteria presently used in cdma200 1× and 1×EV-DV systems for link supervision.

FIG. 4b illustrates one of several exemplary alternatives to the framing based approach described above. Here, mobile station 12 accumulates received bit energy for the PCBs based on a sliding window approach wherein mobile station 12 evaluates the received bit energy for PCB's within a sliding window of a defined width. With the sliding window approach, mobile station 12 may perform coherent or non-coherent accumulation of received bit energy within the window for purposes of evaluating whether the accumulated energy for a given window position has sufficient total energy for purposes of link supervision. Generally, the mobile station 12 defines a fixed window width and slides or otherwise increments the window's position and time relative to the 800 Hz stream of PCB's one bit at a time. Of course, mobile station 12 may vary, possibly dynamically, the width of the window and/or its bit wise incrementing.

Whether the mobile station 12 uses a frame-based PCB energy evaluation or a sliding window based evaluation, mobile station 12 generally bases its link supervision on some form of a sufficiency metric or other evaluation criteria. An exemplary sufficiency metric for the frame-based supervision approach requires the mobile station to qualify its characterization of the received signal as absent based on receiving a defined number of bad frames of PCB's on the power control sub-channel. Here, the “bad” qualifier is determined based on comparing the cumulated bit energy for each frame to a defined received signal energy threshold, with the frame being characterized as bad if its accumulated energy value falls below the defined energy threshold. The sufficiency metric may be based on receiving the defined number of bad frames consecutively, or based on some ratio of bad frames to good frames. Here, the “good” frame qualifier indicates a frame of PCB's having an accumulated measure bit energy at least equal to the defined energy threshold.

If a sliding-window approach is used, mobile station 12 may adopt any one of a number of exemplary approaches to link supervision. With sliding window approach, link supervision may be based on coherently or non-coherently accumulating bit energies within the sliding window. The accumulated bit energies taken across a series of window positions may be evaluated based on a sufficiency metric that, for example, requires a given ratio of good accumulated energy values to bad accumulated energy values. Here, the good and bad accumulated energy values may be determined by comparing the accumulated energy value for each window position against a defined energy threshold similar to the frame-based approach described earlier. With this sliding window approach, the mobile station 12 may make “soft” decisions in terms of characterizing the supervised forward link signal as either present or absent. That is, the mobile station 12 may determine the signal's absence as being indicated by a given ratio of bad accumulated energy values. Of course, mobile station 12 might also adopt a sufficiency metric based on consecutive bad accumulated energy values corresponding to successive window positions.

Mobile station 12 might employ a similar sufficiency metric in terms of evaluating whether the supervised signal has “return.” Thus, mobile station 12 might suspend its reverse link transmission responsive to characterizing the forward link signal as absent and then use either the sliding window and/or frame based approach to accumulated bit energy evaluation in dependence on a second sufficiency metric that the mobile station 12 uses to determine whether it has detected sufficient signal energy to change the characterization of the supervised signal from absent to present. Thus, if mobile station 12 detects a return of the supervised signal within a qualified time and/or count (e.g., frames or windows) it may resume transmission on the reverse link based on the assumption that the loss of the supervised signal represented a transient degradation in channel conditions rather than a termination of the connection by the base station 40.

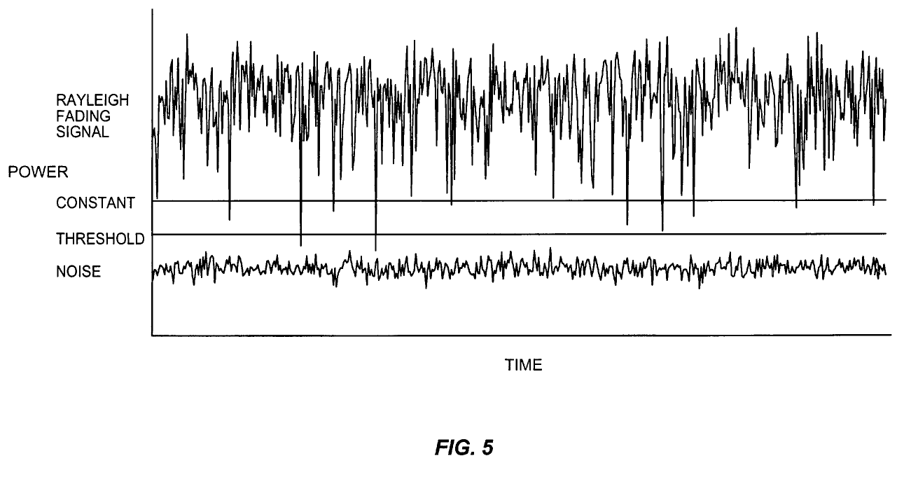

FIG. 5 is an exemplary diagram of signals associated with the mobile station 12 making energy-based link supervision decisions. The mobile station's receiver includes an energy detector and FIG. 5 plots a Gaussian noise signal seen by the mobile station's detector. The defined energy threshold for link supervision purposes must be set a sufficient level above this noise floor to ensure adequate protection against false alarms as regards erroneously indicating a loss of this supervised signal. Similarly, the graph depicts the expected power level of the constant signal being supervised, and further depicts the varying signal level of the supervised signal passed through a Rayleigh Fading Channel. Although these signals are shown simultaneously, those skilled in the art will understand that some of these signals may not be simultaneously present at the mobile station and the diagram is simply meant to provide a graphical depiction of the relative received signal power levels that influence setting the defined energy threshold used for link supervision.

To gain an intuitive understanding of the detector performance, consider first the case of the AWGN channel. The signals of importance to the detector are the Gaussian noise (the first line moving from the bottom of the graph upward), the defined energy/power threshold (second curve) and the constant power signal (third line). Increasing and decreasing the signal-to-noise ratio (SNR) corresponds to moving the constant power signal level up and down, respectively. The distance from the signal power to the supervision energy threshold (i.e. distance from the third line to the second line) determines the probability that the detector does not detect the presence of the supervised signal given that a signal actually was transmitted (i.e., the probability of missed detection). The distance from the defined energy threshold to the Gaussian noise power (i.e. the distance from the first line to the second line) determines the probability that the detector falsely detects the presence of the supervised signal given that no signal was transmitted (i.e., the probability of false detection).

Increasing or decreasing the SNR of the constant power signal while maintaining a fixed supervision threshold increases or decreases the probability of missed detection, i.e., increases or decreases the probability that the mobile station's detector falsely reports the absence of the supervised signal. However, it has no effect on the probability of false detection, in part because such changes in supervised signal SNR do not change the distance from the supervision threshold to the Gaussian noise power.

Where the supervised signal is received through a Rayleigh fading channel, the signals of importance to the mobile station's detector are the Rayleigh fading signal (the top line), the supervision threshold (second line) and the Gaussian noise (first line). If the thresholds are the same for the AWGN case and Rayleigh fading case, the probabilities of false detection are the same in both cases. If the Bit Error Rate (BER) were kept constant, the average power of the Rayleigh fading signal is much larger than that of the signal in the AWGN channel. Therefore, the probability of missed detection is smaller in the Rayleigh fading case than that in the AWGN case. In that sense, the AWGN can be considered a worst-case scenario.

If the BER increases with the Rayleigh fading channel case while the supervision threshold remains the same, the average Rayleigh fading signal power will move towards that of the signal in AWGN channel (the fourth line will move towards the third line) and the probability of missed detection in the Rayleigh fading case approaches that of the AWGN case. At some point, the two probabilities will be the same and, beyond that, the probability of missed detection in the Rayleigh fading case becomes worse. However, it will have no effect on the probability of false detection because the distance from the threshold to the Gaussian noise power remained the same.

Thus, exemplary link supervision relies on energy detection relative to the supervised signal. Within the context of 1×EV-DV networks for a given MS 12 with no assigned fundicated channel, the mobile station relies on the energy detection of the F-CPCCH subchannel, because the F-CPCCH subchannel is, if the fundicated channel is not assigned, the only dedicated channel for the packet data user in 1×EV-DV systems. In such applications, analysis and simulation, detailed herein, demonstrate that the performance of energy-based link supervision using the F-CPCCH subchannel signal is quite reliable with F-CPCCH BER of four-percent or less. Moreover, supervision performance remains acceptable, even for abnormal channel conditions such as temporary deep fading.

In detailing link supervision performance, it is helpful to review exemplary forward link supervision requirements, which include the following points:

R1: If the call is operating in a normal condition, then the supervision algorithm should not affect the call.

R2: If the base station wants to drop a call by turning off the F-CPCCH subchannel, such action should lead to the mobile station quickly dropping the call, e.g., less than 5 sec.

R3: The base station should not reuse the F-CPCCH subchannel associated with an ungracefully dropped call for a defined time T_{b} set in accordance with expected performance of energy-based link supervision at the mobile station (an exemplary range for T_{b} is around 5 to 10 seconds).

R4: If the call is operating in an abnormal condition, such as the F-CPCCH subchannel's received Eb/No is low, the mobile station should respond by at least temporarily suspending its reverse link transmissions; such action would greatly benefit the reverse link capacity.

R5: If the abnormal situation continues, the mobile station should drop the call by terminating its reverse link transmissions; however, if the situation improves, i.e., the F-CPCCH subchannel's received Eb/No returns to reasonable levels, within Tₛ or less seconds, the call should not be dropped and the mobile station should return-to normal operation and resume its reverse link transmissions.

Where energy-based supervision utilizes the frame metaphor, the supervision algorithm may be based on a series of 20 msec. observation results. As noted earlier, such operation has consistency with the FER-based fundicated channel supervision used in cdma2000 1× networks. On that point, one recalls that in cdma2000 1× systems a frame is declared good or bad every 20 msec. Thus, an exemplary bit energy-based supervision of the F-CPCCH subchannel declares received frames of PCBs as good or bad frames every 20 msec. based on the following exemplary procedure:

Every 20 msec., the mobile station measures the received energy, normalized by the noise density, for each power control command.

The sum of the received energies, 16 energies per 20 msec., is compared against the threshold, which has, in one embodiment, an exemplary value of 17≈12.3 dB. If the sum of the accumulated energy is larger (smaller) than the threshold, it is declared a “good” (“bad”) frame. A good frame implies the existence of good quality power control commands, and a bad frame implies that the power control commands are either absent or of insufficient quality.

The probability, known as the false alarm probability, that the mobile station declares a good frame given that the base station turns off the F-CPCCH subchannel is determined, by simulation, to be 5.391×10⁻³. Note that the distance of the threshold, 12.3 dB, relative to the background noise level determines the false alarm probability. Thus, the false alarm probability is not dependent upon the channel conditions (AWGN, fading, or multipath) or the target BER set by the base station.

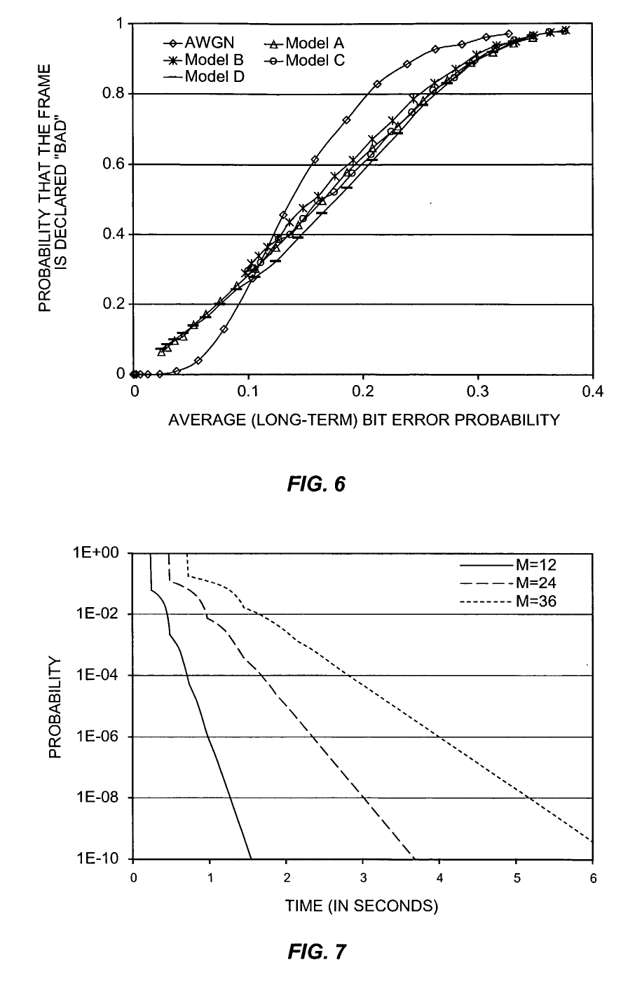

The detection (or missed detection) probability, however, does depend on the channel quality and the target BER set by the base station, which may be seen in FIG. 6. FIG. 6 plots the probability of characterizing the supervised signal as having insufficient quality for supervision purposes as a function of the average BER for the channel conditions are given in Tables 1 and 2 given below:

TABLE 1
Channel Models

| Channel | | | | |
|---|---|---|---|---|
| Model | Multi-path Model | # of Fingers | Speed (Km/hr) | Fading |
| Model A | Pedestrian A | 1 | 3 | Jakes |
| Model B | Pedestrian B | 3 | 10 | Jakes |
| Model C | Vehicular A | 2 | 30 | Jakes |
| Model D | Pedestrian A | 1 | 120 | Jakes |

TABLE 2
Fractional Recovered and Unrecovered Power

| | Finger 1 | Finger 2 | Finger 3 | FURP |
|---|---|---|---|---|
| Model | (dB) | (dB) | (dB) | (dB) |
| Ped-A | −0.06 | | | −18.8606 |
| Ped-B | −1.64 | −7.8 | −11.7 | −10.9151 |
| Veh-A | −0.9 | −10.3 | | −10.2759 |

One interesting characteristic is the asymptotic value illustrated in FIG. 6 when the bit error rate (X-axis) approaches its worst value of 0.5. A BER of 0.5 occurs where Eb/No=0 (−∞dB), and in this case the probability of declaring a frame as bad is (1—probability of false alarm). Since the false alarm probability for the assumptions above is 5.391×10⁻³, the asymptotic value of FIG. 6 (as BER goes to 0.5) is 1—5.391×10⁻³.

In terms of the sufficiency metric used by mobile stations in their energy-based forward link supervision, various approaches might be used. In the frame-oriented approach to energy-based supervision, the following exemplary algorithm may be used:

A mobile station with an assigned PDCH but without an assigned fundicated channel shall monitor F-CPCCH subchannel Eb/Nt as described above and make binary decisions (good or bad frame) every 20 msec. based on accumulating the bit energies for the PCBs received in each frame;

If Nb bad frames are observed, the mobile station shall turn off its transmitter—later analysis herein analyzes performance for Nb equal to 12, 24 or 36 frames;

Once the mobile station suspends its reverse link transmission responsive to receiving Nb bad frames, it starts a supervision timer Ts, which may be set to an exemplary value of five seconds; ???“and” or “or” ???

If Ng good frames are observed within the timeout period of the supervision timer, then the mobile station resumes its normal operation, if not the mobile station drops the call—Ng=6 and 4 are considered herein although other values may be used.

With the above algorithm, the sufficiency metric used by mobile station's in energy-based link supervision may be summarized as (1) count the number, Nb, of bad frames received, either as a ratio of bad-to-good frames, or, in an exemplary embodiment, Nb is a count of consecutively received bad frames; and (2) if Nb reaches a defined limit, characterize, for purposes of link supervision, the supervised signal as absent.

The mobile station might employ a second sufficiency metric, with that second metric used to evaluate whether an absent supervised signal has “returned.” That is, once the mobile station has characterized the supervised signal as absent and suspended its reverse link transmissions, the mobile station may count good frames (either as a ratio of bad-to-good, or, preferably, on a consecutively received basis) to determine whether the supervised signal is only temporarily absent. Thus, the mobile station first characterizes the supervised signal as absent, suspends its reverse link transmission, times the absence and then either (1) resumes communication if the signal returns, or (2) terminates transmission and drops the call.

From the base station's perspective, one of the primary considerations is to accommodate the timing of energy-based link supervision at the mobile station to ensure that the mobile station is given sufficient time to recognize when the base station ungracefully drops a call. Thus, a given BS 40 may impose a delay on the reassignment of a F-CPCCH subchannel that was previously associated with an ungracefully dropped call. In an exemplary embodiment, BSs 40 impose a reassignment delay of Tb seconds under such circumstances. Tb has an exemplary value of ten seconds, although other values may be used.

With an exemplary sufficiency metric based on counting the number of consecutive bad frames, a false alarm occurs if the mobile station detects Nb consecutive bad frames where the base station's power control commands sent via the F-CPCCH subchannel have a reasonable BER. If the operating condition is 5% BER with AWGN channel conditions, then the probability of Nb=12 consecutive bad frames from an arbitrary frame is (0.024)¹². Even assuming a call duration of 100 minutes, the probability that such a false detection event occurs has an upper bound of 100 (min)×60 (sec/min)×50 (frames/sec)×(0.024)¹². Thus, the upper bound on the probability of erroneously detecting twelve consecutive bad frames is less than 10⁻¹³.

Performance of the contemplated energy-based supervision may be measured by looking at the time needed by a given MS 12 to drop a call responsive to the BS 40 turning off the F-CPCCH subchannel at time t0. Such analysis may be based on the above given false alarm probability of 5.391×10⁻³, so channel conditions and BER are irrelevant. The analysis is based on the following definitions: S_{N}=Prob {N consecutive frames are observed but N_{b} consecutive bad frames are not observed}=Prob {The Last frame of the first N_{b} consecutive bad frames occurs after N}

$$\begin{matrix}{S}_{N} = Prob \{ N consecutive frames are observed but {N}_{b} consecutive bad frames are not observed \} \\ = Prob \{ The Last frame of the first {N}_{b} consecutive bad frames occurs after N \} \\ = {p}_{N + 1} + {p}_{N + 2} + {p}_{N + 3} + L = 1 - {\sum }_{i = 1}^{N} {p}_{i} ,\end{matrix}$$

where P_{N}=Prob {N-th frame is the last frame of the first N_{b} consecutive bad frames}. Recursive solutions for P_{N} and S_{N} may be obtained.

S_{N} is shown in FIG. 7 for different numbers of consecutive bad frames, e.g., Nb=M, where M=12, 24, etc. One sees that the MS 12 detects the absence of the F-CPCCH subchannel signal in less than 4 second with higher than 1−10⁻¹⁰ probability where the value of Nb equals twelve or twenty-four consecutive bad frames. Even for a value of thirty-six (Nb=36) the probability only decreases to approximately 1−10⁻⁸. Thus, MS 12 may be expected to shut off its transmitter with a high degree of reliability responsive to deteriorating channel conditions as sensed based on the mobile station's energy based monitoring of the F-CPCCH subchannel signal.

Once the MS 12 has detected such deterioration and suspended its reverse link transmissions, it will, according to the exemplary supervision approach detailed earlier herein, terminate (i.e., drop) the current call unless it receives the defined number, Ng, of good frames within time Ts. If Ts equals five seconds and Ng equals six, the probability that six consecutive good frames are observed starting from an arbitrary position is (5.391×10⁻³)⁶≈2.45×10⁻¹⁴. Since there are 250 frames in a five second interval, the probability that six consecutive good frames are observed during five seconds has an upper bound of 250×(2.45×10⁻¹⁴), which is less then 1×10⁻¹¹. A similar calculation will show that the probability is bounded by 2.11×10⁻⁷ for four consecutive good frames (Ng=4). On the basis of this analysis, one concludes that the MS 12 will turn off its transmitter in less than five seconds and then drop the call within another five seconds with probabilities of 1−1×10⁻¹⁰ and 1−2.11×10⁻⁷, respectively, for Nb=6 and Ng=4.

Moreover, if the base station indicates a dropped call by turning off the F-CPCCH subchannel, the above performance probabilities indicate that a reassignment delay of ten seconds for the F-CPCCH subchannel is sufficient. That is, if the BS 40 waits ten seconds before reassigning the subchannel associated with an ungracefully dropped call, the MS 12 involved in that call will have had sufficient time to recognize the call's loss via its energy-based supervision of the subchannel signal as the probability that the MS 12 drops the call within five seconds responsive to the loss of the subchannel signal is greater than 1−2.11×10⁻⁷.

Thus, the overall performance of the network 10 as regards energy-based link supervision depends on the MSs 12 being able to reliably detect the presence or absence of the supervised forward link signal, e.g., the F-CPCCH subchannel signal, and, moreover, on the BSs 40 adopting channel reassignment delays consistent with the expected supervision timing of the MSs 12. On that latter point, a more detailed look at the exemplary supervision sufficiency metrics used by MSs 12 is of interest. Consistent with the above discussion, these two metrics are (1) the time required by a given MS 12 to shut off its transmitter if energy-based supervision characterizes the received Eb/No of the supervised signal as insufficient, and (2) the time required by the MS 12 to resume operation if the Eb/No changes from unacceptable to acceptable.

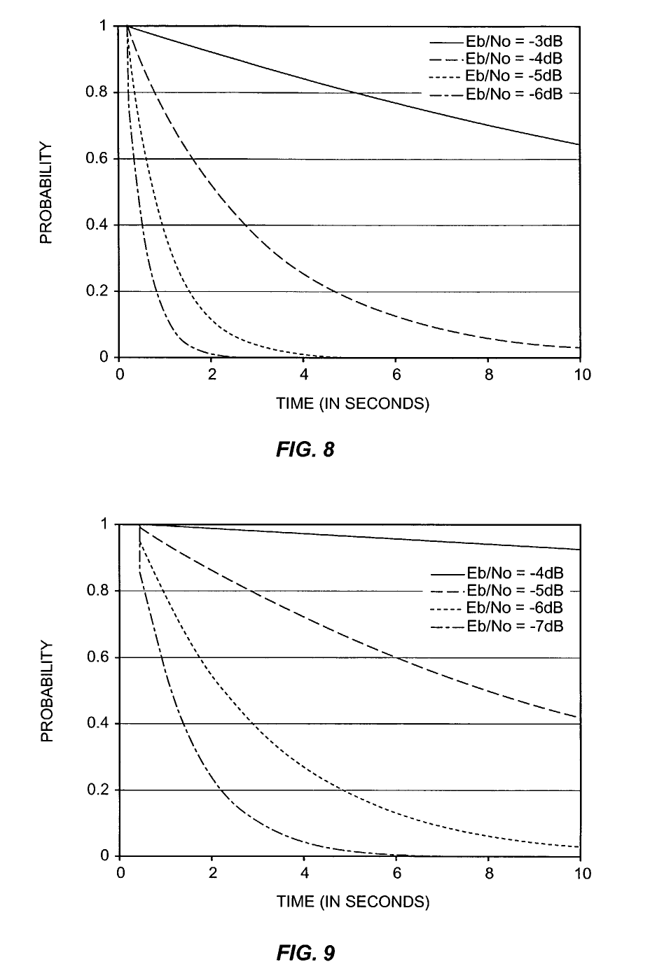

To conserve reverse link capacity, the timing of (1) should be small and the timing of (2) should be less than five seconds or thereabouts to avoid undesirable call drops. FIGS. 8 and 9 illustrate the probabilities that the mobile station's transmitter is not turned off using energy-based link supervision for various received Eb/No values under AWGN channel conditions for first sufficiency metric values (i.e., Nb counts) of twelve and twenty-four, respectively. Thus, in FIG. 8, with a consecutive bad frame count, Nb, of twelve and an Eb/No=−4 dB or less, the MS 12 characterizes the F-CPCCH subchannel as absent within a reasonable time, but has more difficulty detecting such signal loss if the received Eb/No is −3 dB or better. In the range of −4 dB<Eb/No<−3 dB, the supervision behavior is somewhat uncertain. FIG. 9 shows that with an Nb count of twenty-four, and Eb/No of −6 dB or less, signal loss is detected in a reasonable time, but the MS 12 has more difficulty detecting such loss at an Eb/No of −5 dB or better. In the range of −6 dB<Eb/No<−5 dB, the mobile station's supervision behavior is somewhat uncertain.

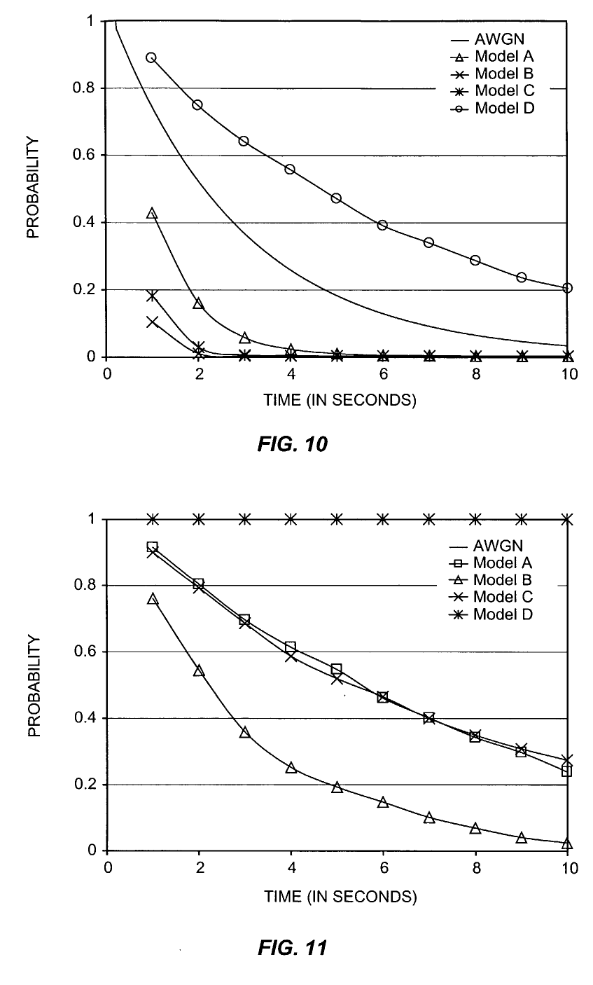

Supervision performance in fading channels without power control is shown in FIGS. 10 and 11. Comparing with FIG. 9, the performance with fading models A, B, and C is similar to that in AWGN with 1-2 dB lower Eb/No. Therefore, for the same average received Eb/No, the MS 12 turns off its transmitter more quickly when operating in channel models A, B, or C. For mobile stations operating in the channel type given by model D (speed of 120 mph), there is some small chance that fading phenomenon might increase the instantaneous Eb/No and thereby make the observation of twelve consecutive bad frames less likely. Thus, where the mobile station's operating conditions fit channel model D, the responsiveness of the energy-based supervision algorithm might lag that of other, more favorable conditions.

FIG. 11 illustrates a similar tendency where the channel model is AWGN or model D, and the average received Eb/No is 0 dB or better. In such circumstances, the probability that the MS 12 will not observe twelve consecutive bad frames within ten seconds is higher than 1−1×10⁻⁹. However, for channel models A, B, or C, there is some appreciable chance that the MS 12 successfully detects twelve consecutive bad frames within ten seconds.

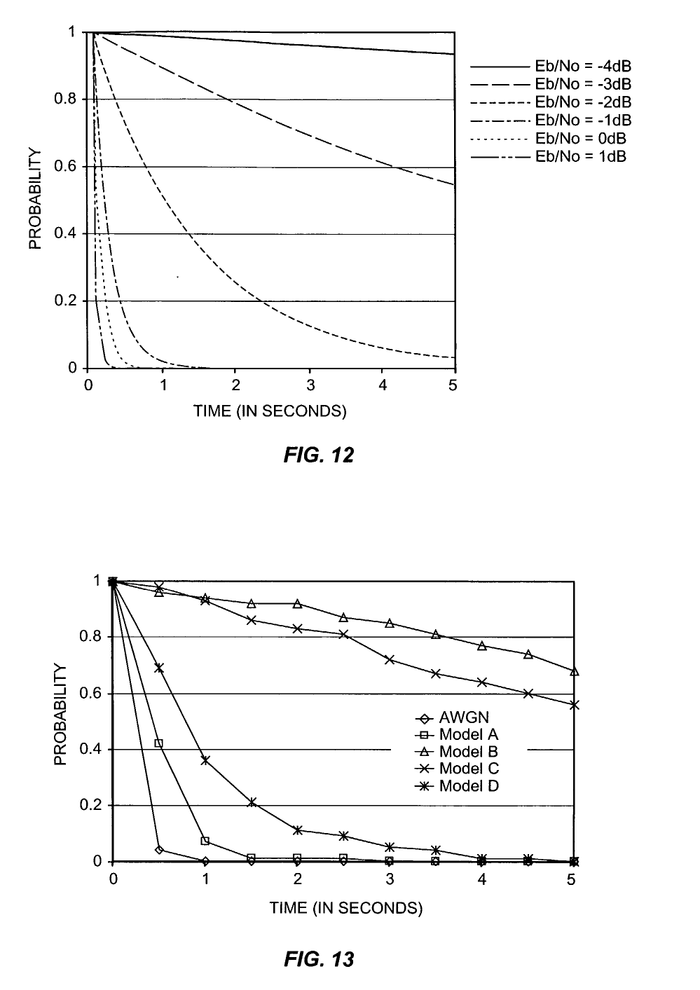

Analysis of the second sufficiency metric, the one used by MSs 12 to time the termination of resumption of reverse link transmissions, also is of interest. In a first case, this second sufficiency metric might be defined as requiring the MS 12 to see six consecutive good frames, Ng=6, within some defined time, such as five seconds, of suspending its transmission. FIG. 12 illustrates the probability that the MS 12 does not detect six consecutive good frames under AWGN channel conditions responsive to an improving received Eb/No. As illustrated, if the received Eb/No returns to 0 dB or more, MS 12 returns to normal operation (resumes its suspended reverse link transmissions) in less than one second.

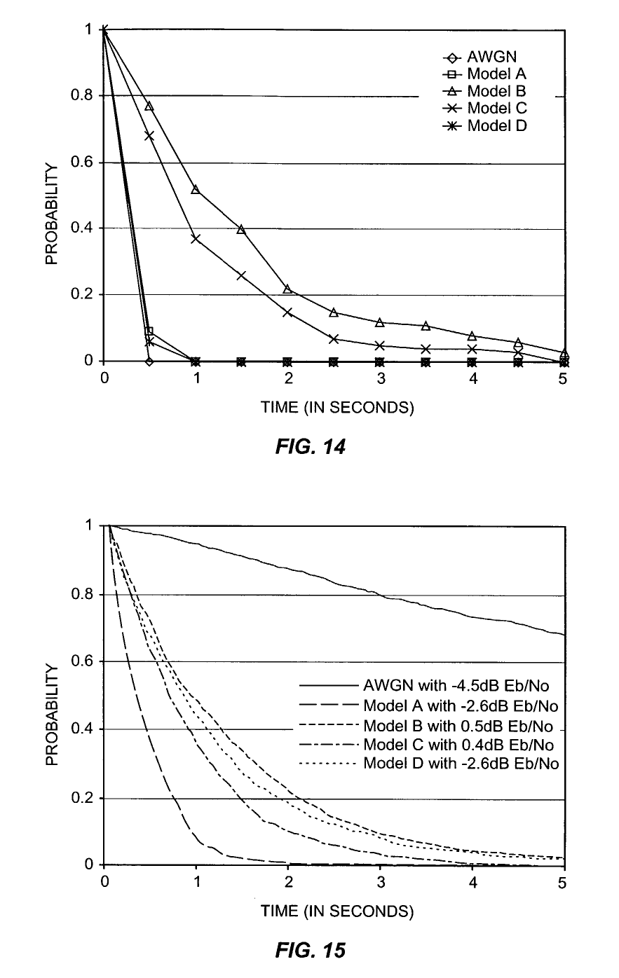

FIGS. 13 and 14 illustrate performance for the fading channel case with no power control of the subchannel signal by the MS 12. From FIG. 13, if Eb/No returns to 0 dB but the channel is still experiencing fading, such as under model B or C conditions, there is some chance that the MS 12 will drop the call rather than treat it as only temporarily degraded and resume transmission because the MS 12 may not detect six consecutive good frames during the suspension period. From FIG. 14, however, if Eb/No returns to about 4 dB, then the probability of satisfying the sufficiency metric within the supervision timer timeout is quite high, even for fading channel conditions. Therefore, if the deep fade duration in the forward link is less than the supervision timer (e.g., five seconds), the current call is not dropped due to the energy-based supervision operations of the MS 12.

Decreasing the good-frame count Ng increases the probability that a call in a poor channel condition will not be dropped. That is, lowering the required number of consecutively good frames increases the probability that the second sufficiency metric will be satisfied within the time limits of the supervision timer, in which case the MS 12 resumes transmission rather than terminate the call. For example, consider the case of Ng=4.

FIG. 15 shows the probability that four good frames are not observed for several channel models when the F-CPCCH BER is 20%. That is, for each channel model, the Eb/No value is chosen for a FER of 20%. One sees that the probability is less than 0.03 under all fading conditions considered after five seconds, which represents the timeout period of the nominal supervision timer. Thus, even if the MS 12 turned off its transmitter and the channel conditions were such that the BER of 20% remained, there is a 97% chance that the MS 12 will exit supervision and resume normal reverse link operations in support of the current call.

Thus, the above detailed analysis supports the assertion that under almost all reasonable operating conditions, the contemplated energy-based supervision of the F-CPCCH subchannel (or other available dedicated forward link channel) provides reliable detection of signal loss and its possible return within defined supervision time limits. Moreover, even if the MS 12 suspends reverse link transmission under unfavorable channel conditions (e.g., BER for the F-CPCCH of about 20% with Rayleigh fading), the probability that the MS 12 will successfully detect a return of the supervised channel signal is quite high, and will therefore reliably exit the supervision suspension and resume normal operation.

Thus, in accordance with the above details, energy-based supervision yields more than acceptable performance and detailed analysis of the approach compares favorably with traditional BER-based supervision schemes that require the presence of a fundicated channel. The inventive supervision approach may be summarized as (1) monitor the received energy of a dedicated channel signal transmitted on the link to be supervised; (2) evaluate the sufficiency of the received energy relative to a first sufficiency metric; (3) suspend operations (i.e., transmission on the return link) and start a supervision timer responsive to characterizing the supervised signal as absent (insufficient received energy) or maintain normal operations responsive to characterizing the supervised signal as present (sufficient received energy); (4) evaluate the absence of the supervised signal according to a second sufficiency metric which time-qualifies the signal loss; and (5) terminate the current call if the supervised signal does not satisfy the second sufficiency metric within the defined supervision timeout, or resume operations if the second sufficiency metric is satisfied within the supervision timeout.

While exemplary energy-based supervision is detailed in the context of F-CPCCH subchannel supervision in 1×EV-DV networks, those skilled in the art will readily appreciate that energy-based supervision is directly applicable to other signals and other network types. Thus, the present invention is limited not by the above discussion but rather by the scope of the following claims and their reasonable equivalents.

What is claimed is:

1. A method of forward link supervision in a wireless communication network comprising:
receiving a signal at a mobile station that is transmitted by the network to the mobile station on a forward link communication channel;
determining whether the received signal has sufficient or insufficient signal quality by measuring energy of the received signal; and
suspending reverse link transmission by the mobile station if the received signal has insufficient signal quality for a first time period.

2. The method of claim 1, wherein the first time period is N×1.25 milliseconds, and further wherein N is a desired number of 1.25 millisecond intervals.

3. The method of claim 1, further comprising re-enabling reverse link transmission by the mobile station after suspending reverse link transmission if the received signal has sufficient signal quality for a second time period.

4. The method of claim 3, wherein the second time period is M×1.25 milliseconds, and further wherein M is a desired number of 1.25 millisecond intervals.

5. The method of claim 1, further comprising dropping a current call being supported by the mobile station if the received signal continues to have insufficient signal quality for a defined time period that includes the first time period.

6. The method of claim 1, further comprising:
performing forward link supervision by detecting received data errors on a fundicated channel signal received by the mobile station if the fundicated channel signal is available; and
performing forward link supervision by measuring energy of the received signal if a fundicated channel is not available.

7. The method of claim 1, wherein the received signal comprises a power control channel signal and wherein determining whether the received signal has sufficient or insufficient signal quality by measuring energy of the received signal comprises measuring received bit energies of the received signal.

8. The method of claim 1, wherein determining whether the received signal has sufficient or insufficient signal quality comprises:
measuring bit energies for received bits in the received signal in each of a number of successive frames of time;
assessing a frame as bad if a received bit energy value for the frame falls below a defined energy threshold; and
characterizing the signal quality of the received signal as insufficient responsive to receiving a defined number of bad frames.

9. The method of claim 8, wherein the received bit energy value is a per bit value such that the frame is assessed as bad if the bit energy of one or more received bits within the frame falls below the defined energy threshold.

10. The method of claim 8, wherein the received bit energy value is a cumulative energy value, and wherein measuring bit energies for received bits in each frame comprises accumulating the bit energy of each received bit for the frame as the cumulative energy value.

11. The method of claim 8, further comprising assessing a frame as good if the received bit energy value for the frame is at least equal to the defined energy threshold.

12. The method of claim 11, further comprising characterizing the received signal as having sufficient signal quality responsive to receiving a defined number of successive good frames.

13. The method of claim 12, further comprising resuming reverse link transmission responsive to determining that the received signal has sufficient signal quality.

14. The method of claim 1, wherein determining whether the received signal has sufficient or insufficient signal quality by measuring energy of the received signal comprises:
defining a sliding window of time;
accumulating bit energy for the received signal at successive sliding window positions to obtain successive accumulated energy values; and
characterizing the received signal as having insufficient signal quality if the accumulated energy values do not meet a defined sufficiency metric.

15. The method of claim 14, wherein the sufficiency metric is defined as a number of successive accumulated energy values that are below a sufficiency threshold.

16. The method of claim 14, wherein the sufficiency metric is defined as a ratio of accumulated energy values that are below a sufficiency threshold to accumulated energy values that are at least equal to the sufficiency threshold.

17. The method of claim 1, wherein the received signal is transmitted by the network under power control by the mobile station, and further comprising sending power control commands from the mobile station to the network to increase the transmit power for the received signal responsive to degrading reception conditions at the mobile station for the received signal.

18. The method of claim 17, wherein sending power control commands from the mobile station to the network to increase the transmit power for the received signal responsive to degrading reception conditions at the mobile station for the received signal comprises requesting that the network increase transmit power for the received signal responsive to detecting that the received signal has insufficient signal quality at the mobile station.

19. The method of claim 1, wherein suspending reverse link transmission by the mobile station if the received signal has insufficient signal quality for a first time period comprises suspending reverse link transmission by the mobile station responsive to detecting that the received signal has had insufficient signal quality for a time at least equal to the first time period.

20. The method of claim 19, further comprising re-enabling reverse link transmission by the mobile station if the received signal resumes having sufficient signal quality before a suspension time-out period expires.

21. The method of claim 20, further comprising time-qualifying the return to sufficient signal quality for the received signal such that the received signal must have sufficient signal quality for longer than a defined time before reverse-link transmission is re-enabled.

22. The method of claim 20, further comprising terminating reverse link transmission by the mobile station upon expiration of the suspension time-out period.

23. A method of supervising a communication link between first and second transceivers in a wireless communication network, wherein the first transceiver transmits a signal on a communication channel associated with the link to be supervised, the method comprising:
receiving the signal at the second transceiver;
measuring energy of the received signal at the second transceiver;
determining whether the measured energy satisfies a sufficiency metric; and
characterizing the communication link as unavailable if the measured energy does not satisfy the sufficiency metric.

24. The method of claim 23, wherein the defined sufficiency metric is based on a defined energy threshold taken as representative of the received signal being present, and further comprising setting the defined energy threshold based on a background noise level at the second transceiver.

25. The method of claim 24, wherein setting the defined energy threshold based on the background noise level comprises setting the defined energy threshold an amount above the background noise level based on a desired false alarm probability, where a false alarm is defined as falsely characterizing the received signal as absent.

26. The method of claim 23, wherein determining whether the received energy satisfies the defined sufficiency metric comprises:
grouping received bits of the received signal into successive frames;
identifying a given frame as a bad frame if an accumulated energy of the received bits in the frame falls below a defined energy threshold; and
determining that the received signal does not satisfy the defined sufficiency metric based on receiving a defined number of bad frames.

27. The method of claim 26, further comprising characterizing the received signal as present based on receiving a defined number of good frames within a defined time of the received signal being absent, wherein a given frame is identified as a good frame if the accumulated energy of the received bits in the frame at least meets the defined energy threshold.

28. The method of claim 27, further comprising requiring that the defined number of good frames be consecutively received.

29. The method of claim 27, further comprising that the defined number of bad frames be received according to a defined ratio of bad frames to good frames.

30. The method of claim 26, further comprising requiring that the defined number of bad frames be consecutively received.

31. The method of claim 26, further comprising defining each frame to have a frame time of about twenty milliseconds.

32. The method of claim 23, wherein determining whether the received energy satisfies the defined sufficiency metric comprises:
defining a sliding window and forming groupings of received bits of the received signal based on the sliding window;
identifying a given grouping as a bad grouping if an accumulated energy of the received bits in the grouping falls below a defined energy threshold; and
determining that the received signal does not satisfy the defined sufficiency metric based on identifying a defined number of bad groupings.

33. The method of claim 32, further comprising forming the accumulated energy of each grouping based on coherently combining measured bit energies of the received bits in the grouping.

34. The method of claim 32, further comprising forming the accumulated energy of each grouping based on non-coherently combining measured bit energies of the received bits in the grouping.

35. A mobile station for use in a wireless communication network, the mobile station comprising:
a transceiver unit to receive signals on a forward link from the network and transmit signals on a reverse link to the network;
control logic to supervise the forward link on an energy-basis by detecting an abnormal forward link condition based on:
receiving a signal transmitted by the network on the forward link;
measuring energy of the received signal; and
detecting the abnormal forward link condition by determining whether the measured energy meets a sufficiency metric.

36. The mobile station of claim 35, wherein the mobile station alternatively performs forward link supervision on an error-rate basis if a forward link fundicated channel is assigned to the mobile station.

37. The mobile station of claim 36, wherein the mobile station performs forward link supervision on an error-rate basis by detecting a Frame Error Rate (FER) of data frames received on the forward link fundicated channel.

38. The mobile station of claim 35, wherein the mobile station suspends reverse link transmission responsive to detecting the abnormal forward link condition.

39. The mobile station of claim 35, wherein the mobile station resumes reverse link transmission if the abnormal forward link condition does not persist longer than a defined supervision timeout.

40. The mobile station of claim 35, wherein the mobile station measures the received energy of the received signal by generating accumulated energy values, with each accumulated energy value corresponding to the combined energy of a defined number of received signal bits.

41. The mobile station of claim 40, wherein the mobile station performs non-coherent combining of the received signal bits to generate the accumulated energy values.

42. The mobile station of claim 40, wherein the mobile station performs coherent combining of the received signal bits to generate the accumulated energy values.

43. The mobile station of claim 40, wherein the mobile station generates the accumulated energy values by grouping the received signal bits into successive frames, with each frame comprising a defined number of received signal bits.

44. The mobile station of claim 43, wherein the received signal is a power-control signal comprising power control bits transmitted at a defined rate, and wherein the mobile station defines the frames as successive windows of a fixed time such that each frame spans a fixed number of power control bits.

45. The mobile station of claim 43, wherein the defined sufficiency metric comprises a first sufficiency metric defining a limit on the number of bad frames that can be received by the mobile station within a defined time, wherein a bad frame is defined as a frame having an accumulated energy value that falls below a defined energy threshold.

46. The mobile station of claim 45, wherein the mobile station starts a supervision timer responsive to detecting the abnormal forward link condition, and wherein the mobile station evaluates the received signal during a timeout period of the supervision timer based on a second sufficiency metric used to determine whether the abnormal forward link condition is persistent.

47. The mobile station of claim 46, wherein the mobile station terminates a current call if the abnormal forward link condition is persistent and resumes reverse link transmissions for the current call if the abnormal forward link condition is not persistent.

48. The mobile station of claim 47, wherein the second sufficiency metric requires the mobile station to receive a defined number of good frames within the timeout period of the supervision timer, wherein a good frame is defined as one having an accumulated energy value above the defined energy threshold.

49. The mobile station of claim 40, wherein the mobile station generates the accumulated energy values by grouping the received signal bits as successive, overlapping groups of bits spanned by a sliding window of a defined width.

50. The mobile station of claim 35, wherein determining whether the measured received energy meets a defined sufficiency metric comprises determining whether the received signal is received at sufficient or insufficient signal quality, wherein received signal quality is assessed based on the measured received energy.

51. The mobile station of claim 50, wherein the first sufficiency metric comprises a time-qualified evaluation wherein the first sufficiency metric is not met if the received signal is received at insufficient signal quality for longer than a first defined period.

52. The mobile station of claim 51, wherein the mobile station suspends reverse link transmission if the first sufficiency metric is not met.

53. The mobile station of claim 52, wherein, after suspending reverse link transmission, the mobile station uses a second sufficiency metric to determine whether to terminate or resume suspended reverse link transmission based on monitoring the received signal quality of the received signal during a second defined period.

54. The mobile station of claim 53, wherein the second sufficiency metric comprises a time-qualified evaluation wherein the second sufficiency metric is met if, during the second defined period, the received signal is received at sufficient signal quality for a third defined period.

55. A mobile station for use in a wireless communication network, the mobile station comprising:
a transceiver unit to receive signals on a forward link from the network and transmit signals on a reverse link to the network; and
control logic to perform forward link supervision on an error-rate basis using a fundicated channel signal from the network if available, and on a signal-energy basis using a power control channel signal from the network if a fundicated channel signal is not available.

56. The mobile station of claim 55, wherein the mobile station performs forward link supervision on a signal-energy basis by measuring received bit energy in the power control channel signal.

57. The mobile station of claim 55, wherein the mobile station performs signal-energy based forward link supervision by making time-qualified measurements of received signal energy for the power control channel signal.

58. The mobile station of claim 57, wherein the mobile station characterizes the power control channel signal as having insufficient signal quality if the measured bit energy of the power control channel signal is below an energy threshold, and as having sufficient signal quality if the measured bit energy of the power control channel signal is above the energy threshold.

59. The mobile station of claim 57, wherein the mobile station suspends reverse link transmission as part of energy-based forward link supervision operations responsive to receiving the power control channel signal at insufficient signal quality for a first defined period.

60. The mobile station of claim 59, wherein, after suspending reverse link transmission, the mobile station terminates reverse link transmission if the signal quality power control channel signal remains insufficient for longer than a suspension time-out period.

61. The mobile station of claim 60, wherein, after suspending reverse link transmission, the mobile station re-enables reverse link transmission if the power control channel signal is received with sufficient signal quality for a defined second period.
